(19) United States
(12) Patent Application Publication
(10) Pub. No.: US 2025/0149581 A1
(43) Pub. Date: May 8, 2025

(54) LITHIUM-CFX BATTERY COMPRISING SOLID POLYMER ELECTROLYTE AND METHOD OF MANUFACTURING THE LITHIUM-CFX BATTERY

(71) Applicant: EAGLEPICHER TECHNOLOGIES, LLC, Joplin, MO (US)

(72) Inventor: Mario Destephen, Joplin, MO (US)

(21) Appl. No.: 18/351,882

(22) Filed: Jul. 13, 2023

Related U.S. Application Data
(60) Provisional application No. 63/389,156, filed on Jul. 14, 2022.

(51) Int. Cl. H01M 4/583; H01M 4/02; H01M 4/04; H01M 4/08; H01M 4/36; H01M 4/38; H01M 4/40; H01M 4/50; H01M 4/62; H01M 4/66; H01M 6/18

(52) U.S. Cl. CPC H01M 4/5835; H01M 4/0404; H01M 4/08; H01M 4/364; H01M 4/382; H01M 4/405; H01M 4/502; H01M 4/62; H01M 4/667; H01M 6/181; H01M 2004/027; H01M 2004/028; H01M 2300/0082; H01M 2300/0091

(57) ABSTRACT

A non-aqueous battery includes: an anode containing lithium, a lithium alloy, or a combination thereof; a cathode includes a cathode active material layer, which contains the a cathode active material and a first solid polymer electrolyte, wherein the cathode active material contains a fluorinated carbon; and a second solid polymer electrolyte between the anode and the cathode, wherein the first and second solid polymer electrolytes independently comprise an ionically conducting polymer and an additive comprising inorganic particles, a lithium salt, an ionic liquid, or a combination thereof. The fluorinated carbon includes a first fluorinated carbon (CFx₁, 0.9<x₁≤1.2), a second fluorinated carbon (CFx₂, 0.4≤x₂<0.9), a third fluorinated carbon (CFx₃, 0.8≤x₃≤1.2) or a combination thereof, wherein the first, second, and third fluorinated carbons have distinct discharge capacities when discharged to 2.5 volts.

### CROSS REFERENCE TO RELATED APPLICATIONS

This application claims the benefit of U.S. Provisional Application No. 63/389,156, filed Jul. 14, 2022, which is incorporated by reference in its entirety herein.

### BACKGROUND

Lithium electrochemical cells, also referred to as batteries, are widely used in a variety of defense, aerospace, medical and consumer products. Many of these products utilize high energy and high power batteries. Due in part to the miniaturization of portable electronic devices, it is desirable to develop even smaller lithium batteries with an increased power capability and service life. One way to develop smaller batteries with increased service life is to develop higher energy cathode materials.

Carbon fluoride (CFx, 0.4<x<1.2) has been used as a cathode material in non-rechargeable batteries, which are also known as Li anode/CFx cathode cells or Li-CFx cells. A battery including a Li-CFx cell is not rechargeable and thus is a primary battery. A Li-CFx cell has high energy density, a long shelf life, and is light in weight to provide high energy density and operation over a wide temperature range.

Despite the improvements, there remains a need to improve the lifespan and shelf-life of a Li-CFx cell.

### BRIEF DESCRIPTION

Disclosed herein is a non-aqueous battery comprising a solid polymer electrolyte and a method of manufacturing the non-aqueous battery.

A non-aqueous battery comprises: an anode comprising an anode active material, wherein the anode active material comprises lithium, a lithium alloy, or a combination thereof; a cathode comprising a cathode active material layer, wherein the cathode active material layer comprises a cathode active material and a first solid polymer electrolyte, and the cathode active material comprises a fluorinated carbon; and a second solid polymer electrolyte between the anode and the cathode, wherein the first and second solid polymer electrolytes independently comprise an ionically conducting polymer and an additive comprising inorganic particles, a lithium salt, an ionic liquid, or a combination thereof, wherein the fluorinated carbon comprises a first fluorinated carbon having a structure of Formula 1, a second fluorinated carbon having a structure of Formula 2, a third fluorinated carbon having a structure of Formula 3, or a combination thereof:

CFx₁, Formula 1

CFx₂, or Formula 2

CFx₃, Formula 3
wherein, 0.9<x₁≤1.2, 0.4≤x₂<0.9, and 0.8≤x₃≤1.2, and
wherein each of the first, second, and third fluorinated carbons have distinct discharge profiles at or above 2.5 volts.

A method of manufacturing a nonaqueous battery comprises: providing an anode comprising an anode active material, wherein the anode active material comprises lithium, a lithium alloy, or a combination thereof; providing a cathode having a cathode active material layer, the cathode active material layer comprising a cathode active material and a first solid polymer electrolyte, wherein the cathode active material comprises a fluorinated carbon; and disposing a second solid polymer electrolyte between the anode and the cathode, wherein the first and second solid polymer electrolytes independently comprise an ionically conducting polymer and an additive comprising inorganic particles, a lithium salt, a polymer ionic liquid, or a combination thereof, wherein the fluorinated carbon comprises the first fluorinated carbon, the second fluorinated carbon, the third fluorinated carbon, or a combination as described hereinabove.

The above described and other features are exemplified by the following figures and detailed description.

### DETAILED DESCRIPTION

During operation of a Li-CFx cell, the CFx produces heat, which can be mitigated through the addition of a second active material with lower heat generation. The nonaqueous liquid electrolyte is beneficial at low temperatures, but at high operating temperatures the discharge rate of the battery including a nonaqueous liquid electrolyte is substantially decreased and can lead to safety issues. In some instances, the combination of CFx (0.4<x<1.2) chemistry with manganese dioxide (MnO₂) has been used to mitigate some undesirable properties of CFx, such as heat generation and poor low temperature performance. The storage of a Li-CFx or a Li-CFx/MnO₂ cell including a liquid electrolyte is limited to only about 10 years. Without being limited by theory, it is understood that over time side reactions between the liquid electrolyte and the anode and/or cathode result in self-discharge of the battery. Both Li-CFx and Li-CFx-MnO₂ chemistries have a low self-discharge (capacity loss) of about 1% to 2% per year. However, self-discharge reactions during storage lead to an increase of passivation layers resulting in increased cell impedance. The increase in impedance translates into reduced power capability especially at low temperatures, which limit the practical shelf-life of the cells. Accordingly, it would be beneficial to provide a Li-CFx/MnO₂ electrochemical cell (battery) having an increased shelf life of more than 10 years and an improved discharge rate at high temperatures, such as above 90° C. or higher.

As used herein, “electrochemical cell” or “cell” may otherwise be referred to as a battery and is intended to refer to any cell that involves electron transfer between an electrode and an electrolyte. The terms electrochemical cell, battery, and cell, thus may be used interchangeably. It should be understood that these references are not limiting, and any cell that involves electron transfer between an electrode and an electrolyte is contemplated to be within the scope of the present disclosure. The electrochemical cell contemplated herein is non-rechargeable, i.e., is a primary electrochemical cell.

As used herein, a C rate is a measure of the rate a cell is charged or discharged relative to its maximum capacity, and is obtained by dividing a total capacity of the cell by a total discharge period of time. A 1 C rate means a current which will discharge the entire capacity in one hour. For example, for a cell with a capacity of 100 ampere-hrs, a C rate discharge would be a discharge current of 100 amperes, a 5 C rate for this battery would be 500 amperes, a C/2 rate would be 50 amperes, and a C/4 rate would be 25 amperes.

The term “charge-discharge efficiency” refers to the ratio of capacity obtained upon discharge divided by the capacity supplied during charge. In other words, charge-discharge efficiency (C_{eff}) is represented by Equation 1:

Equation 1: C_{eff}=Dₙ₊₁/Cₙ×100%

In Equation 1, D is discharge capacity, C is charge capacity, and n is the cycle number.

As used herein, in the context of an electrochemical cell, the term “non-aqueous” means that water is not intentionally present in the electrochemical cell (or battery). In particular, the electrochemical cell (battery) comprises a nonaqueous electrolyte comprising no added water (i.e., no water is added to the electrolyte). Water may be present as a trace or underlying component or contaminant of the materials used to prepare the battery, for example, water may be present as a trace or underlying component or contaminant of an organic solvent or polymer used to prepare the electrolyte. The electrolyte may have a water content of less than 1000 parts per million (ppm), or a less than 250 ppm, or less than 5 ppm.

As used herein, an “oxide” of a metal, or alternatively a specific metal oxide, refers to a compound that consists, or consists essentially of, the recited metal and oxygen. For example, an “oxide” of manganese or a “manganese oxide” refers to a compound that consists or consists essentially of oxygen and manganese.

A “mixture” refers to a physical mixture of the recited materials, each material being distinct or identifiable from the other materials present therein. For example, when the cathode material comprises fluorinated carbon and a manganese oxide, the mixture comprises, or consists of, or consists essentially of a compound that consists or consists essentially of carbon and fluorine and a compound that consists or consists essentially of manganese and oxygen (e.g., MnO₂). As such, a manganese oxide is not intended to refer to or encompass, for example, a mixed metal oxide such as copper manganese oxide.

A “composite” refers to a material formed by combining two or more materials having different physical and/or chemical properties in a manner such that the resulting material, i.e., the composite, has properties different from each material constituting the composite.

As used herein, the “average particle size” refers to a particle diameter in the case of spherical particles, or a longest dimension in the case of non-spherical particles, corresponding to 50% of the particles in a distribution curve in which particles are accumulated in the order of particle size from the smallest particle to the largest particle, and a total number of the accumulated particles is 100%. Average particle size may be determined using a particle size analyzer, a transmission electron microscope (TEM) image, or a scanning electron microscope (SEM) image. As an example of another method, average particle size may be measured by dynamic light-scattering, and counting the number of particles within a predetermined size range, performing data analysis, and calculating an average particle diameter.

Disclosed herein is a non-aqueous battery comprising: an anode comprising an anode active material, wherein the anode active material comprises lithium, a lithium alloy, or a combination thereof; a cathode comprising a cathode active material layer, wherein the cathode active material layer comprises a cathode active material and a first solid polymer electrolyte, and the cathode active material comprises a fluorinated carbon and optionally a manganese oxide; and a second solid polymer electrolyte between the anode and the cathode, wherein the first and second solid polymer electrolytes independently comprise an ionically conducting polymer and an additive comprising inorganic particles, a lithium salt, an ionic liquid, or a combination thereof.

The cathode active material layer can comprise 50 to 95 weight percent, 60 to 95 weight percent, or 70 to 95 weight percent of the cathode active material and 5 to 50 weight percent, 5 to 40 weight percent, or 5 to 30 weight percent of the first solid polymer electrolyte, each based on a total weight of the cathode active material layer.

The inclusion of a solid polymer electrolyte as described herein in the nonaqueous battery minimizes the number of side reactions which occur between the electrolyte and the anode and/or the cathode, increases the shelf life of the battery to greater than 10 years, and provides high temperature stability resulting in improved battery safety. The inclusion of the solid polymer electrolyte in an Li-CFx or Li/CFx-MnO₂ cell containing a fluorinated carbon as described herein improves the safety and shelf-life of the battery. The solid polymer electrolyte eliminates the need for liquid organic electrolytes (very flammable) that are the cause of most safety events in lithium batteries. Without being limited by theory. the solid polymer electrolytes generates less parasitic reactions compared to organic electrolytes, which translate in improved shelf-life.

The cathode active material layer comprises a cathode composition comprising a cathode active material. The cathode active material comprises a fluorinated carbon. The fluorinated carbon comprises a fluorinated carbon represented by Formula 1, a fluorinated carbon represented by Formula 2, a fluorinated carbon represented by Formula 3, or a combination thereof.

CFx₁ Formula 1

CFx₂ Formula 2

CFx₃. Formula 3

In Formula 1, 0.9<x₁≤1.2, or 0.95≤x₁≤1.15, or 0.98≤x₁≤1.10, or x₁ is 1.

In Formula 2, x₂ is 0.4≤x₂<0.9, or 0.5≤x₂0.8, or 0.55≤x₂≤0.70, or x₂ is 0.6.

In Formula 3, x₃ is 0.8≤x₃1.2, 0.9<x₃≤1.2, or 0.95≤x₃≤1.15, or 0.98≤x₃≤1.10, or x₃ is 1.

The fluorinated carbon may be prepared, for example, by contacting a carbon source with a fluorine containing gas. In aspects, the carbon source comprises petroleum coke, beaded petroleum pitch (activated or non-activated), other activated carbon (e.g., charcoal), carbon black, graphite, graphene, graphite nano-platelets, expanded graphite, carbon nanofiber, carbon nanotubes, or a combination thereof. In aspects, the fluorinated carbon is derived from petroleum coke, beaded petroleum pitch, or a combination thereof. The carbon source may affect the discharge properties of the non-aqueous electrochemical cell even when the materials have the same or similar degree of fluorination. For instance, a fluorinated carbon with a carbon to fluorine molar ratio of 1:1 derived from petroleum coke has a different discharge profile than a fluorinated carbon with a similar molar ratio but which is derived from a beaded petroleum pitch.

In aspects, the cathode active material comprises at least one fluorinated carbon. In other aspects, the fluorinated carbon material comprises two or more fluorinated carbon (CFx) materials. In an aspect, the fluorinated carbon comprises a first fluorinated carbon represented by Formula 1, a second fluorinated carbon represented by Formula 2, and a third fluorinated carbon represented by Formula 3. In Formulas 1-3, the values of x₁, x₂ and x₃ are different from one another, or x₁ and x₃ have a value that is the same, but is different from x_{2.} In other aspects, the fluorinated carbon comprises the first or third fluorinated carbon (having the structures of Formula 1 or Formula 3, respectively) and the second fluorinated carbon (having the structure of Formula 2).

The first, second, and third fluorinated carbons each have distinct discharge capacities when discharged to 2.5 volts (V), and distinct discharge capacities when discharged to 1.5 V. In other words, each fluorinated carbon has a discharge capacity above 2.5 V, and a discharge capacity to 1.5 V, which is different from the other two fluorinated carbons. Upon discharge to 1.5 volts, the first fluorinated carbon has a discharge capacity of 800 milliampere hours per gram (mAh/g) to 870 mAh/g, the second fluorinated carbon cathode material has a discharge capacity of from 680 mAh/g to 800 mAh/g. and the third fluorinated carbon cathode material has a discharge capacity of from 825 mAh/g to 875 mAh/g. In an aspect, the discharge capacity is determined at 20° C., a discharge rate of 0.05 C, and when using a polyethylene oxide solid polymer electrolyte.

The two or more fluorinated carbon materials may be derived from the same carbon source (e.g., petroleum coke or pitch) or from different carbon sources. In one aspect, the first fluorinated carbon cathode material, the second fluorinated carbon cathode material, or a combination thereof, are derived from petroleum coke, while the third fluorinated carbon cathode material is derived from petroleum pitch. In aspects, the first and second fluorinated carbon are derived from petroleum coke, and/or the third fluorinated carbon cathode material is derived from petroleum pitch.

The total amount of the fluorinated carbon in the cathode composition may be greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, or greater than or equal to 75 wt %, but less than 90 wt %, based on the total weight of the cathode composition. The total amount of the fluorinated carbon, may be, for example, 5 wt % to 90 wt %, or 10 wt % to 85 wt %, or 15 wt % to 80 wt %, or 20 wt % to 80 wt %, or 25 wt % to 75 wt %, or 30 wt % to 70 wt %, 35 wt % to 65 wt %, based on the total weight of the cathode composition.

When the cathode active material comprises two or more fluorinated carbon materials, the concentration of each of the fluorinated carbons in the cathode composition may be optimized for a given application or use. For example, the total amount of a first fluorinated carbon having the structure of Formula 1, may be from 20 wt % to 70 wt %, or 25 wt % to 65 wt %, or 30 wt % to 60 wt %, based on the total weight of the fluorinated carbon present in the cathode composition. Additionally, or alternatively, the amount of the second fluorinated carbon having the structure of Formula 2 may be 2 wt % to 35 wt %, or 4 wt % to 30 wt %, or 5 wt % to 25 wt %, based on the total weight of the fluorinated carbon present in the cathode composition. Additionally, or alternatively, the amount of the third fluorinated carbon having the structure of Formula 3, may be 15 wt % to 85 wt %, or 20 wt % to 80 wt %, based on the total weight of the fluorinated carbon present in the cathode composition. A weight ratio of the first fluorinated carbon material to the second fluorinated carbon material can be from 5:1 to 1:5, from 4:1 to 1:4, from 3:1 to 1:3, or from 2:1 to 1:2.

The average particle size (particle diameter) of the fluorinated carbon derived from petroleum pitch (e.g., third fluorinated carbon of Formula 3) may be 100 um to 1200 um, or 150 μm to 1000 μm, or 500 μm to 700 μm. The average particle size of the fluorinated carbon derived from petroleum coke (e.g., first fluorinated carbon of Formula 1) may be from 0.1 μm to 300 μm, or 0.5 μm to 100 μm. The average particle size of the fluorinated carbon may be achieved directly, or by particle size reduction. For example, once prepared the fluorinated carbon may optionally be reduced in size by milling or grinding to obtain a material having an average particle size of 0.1 to 300 μm, or 0.1 μm to 200 μm, or 0.5 μm to 50 μm.

The fluorinated carbon derived from petroleum coke may have an average BET surface area of, for example, 120 square centimeters per gram (cm²/g) to 450 cm²/g, or 150 cm²/g to 325 cm²/g, or 180 cm²/g to 250 cm²/g. Fluorinated carbon derived from petroleum pitch has a slightly higher BET surface area of, for example, from 250 cm²/g to 750 cm²/g, or 300 cm²/g to 700 cm²/g, or 350 cm²/g to 650 cm²/g. However, the surface area of the fluorinated carbon is not limited thereto.

The cathode active material may further comprise a metal oxide. The metal oxide may comprise a manganese oxide, for example, a manganese dioxide (MnO₂), such as β-MnO₂ (pyrolusite), Mn⁴⁺O₂ (ramsdellite, orthorhombic manganese dioxide), γ-MnO2, ε-MnO₂, λ-MnO₂, electrolytic manganese dioxide (EMD), chemical manganese dioxide (CMD), or combination thereof. Other forms of manganese oxide, such as MnO, Mn₃O₄, Mn₂O₃, Mn₂O₇, or a combination thereof, may also be present. In various aspects, the cathode active material comprises, consists of, or consists essentially of a fluorinated carbon and a manganese oxide. An electrochemical cell comprising the combination of the manganese oxide and the fluorinated carbon as a cathode active material, results in an improved discharge performance at a higher rates and low temperatures as compared to a nonaqueous battery including only fluorinated carbon as the cathode active material.

The amount of the metal oxide in the cathode composition may be greater than or equal to 5 wt %, greater than or equal to 10 wt %, greater than or equal to 20 wt %, greater than or equal to 30 wt %, or 40 wt %, but less than 90 wt %, based on a total weight of the cathode composition. The amount of the metal oxide may be, for example, 5 wt % to 40 wt %, or 5 wt % to 30 wt %, or 10 wt % to 30 wt %, or 15 wt % to 30 wt %, or 15 wt % to 20 wt %, or 20 wt % to 30 wt %, based on the total weight of the cathode composition. Stated another way, the weight ratio of the fluorinated carbon to the metal oxide such as manganese oxide, is greater than 1:1, for example, 2:1, 4:1, 6:1, 8:1, or 10:1.

The metal oxide has an average particle size of 5 nanometers (nm) to 100 nm, or 10 nm to 75 nm, or 10 nm to 50 nm, or 15 nm to 45 nm, or from 20 nm to 40 nm, or from 23 nm to 37 nm. In aspects, the average particle size of the metal oxide is sufficiently small, such that the particles are easily dispersed around and/or between the larger particles of fluorinated carbon.

In aspects, the cathode composition further comprises a solid polymer electrolyte. The solid polymer electrolyte is described in further detail below. The solid polymer electrolyte in the cathode composition may be the same as or different from the solid polymer electrolyte disposed between the cathode and the anode. An amount of the solid polymer electrolyte in the cathode composition may be optimized to provide a cathode having a high electrode density with enhanced rate capability.

In aspects, the cathode composition further includes a conductive material, a binder, or a combination thereof. The materials included in the cathode composition and their respective amounts are optimized to achieve a high electrode (cathode) density with enhanced rate capability.

The conductive material in the cathode composition comprises carbon black (e.g., Super P, from Timcal), natural and synthetic graphite, graphite derivatives (for example, graphene, graphite nanoplatelets, expanded graphite), carbon nanofibers, carbon nanotubes, non-graphitic forms of carbon, such as coke, charcoal or activated carbon, or a combination thereof. Various metals, for example those in powdered form, may also be used as conductive material in the cathode composition. Examples of such metals include silver, gold, aluminum, titanium, or a combination thereof. The cathode composition may contain the conductive material in an amount of 1 wt % to 15 wt %, or 1 wt % to 10 wt %, based on the total weight of the cathode composition.

The binder in the cathode composition comprises a polymer such as polyvinylidene fluoride (PVDF), polytetrafluoroethylene (PTFE), ultrahigh molecular weight polyethylene (UHMWPE), styrene-butadiene rubber, cellulose, polyacrylate rubber, a copolymer of acrylic acid or an acrylate ester, or a combination thereof. In some aspects, the cathode composition comprises a polymer material that acts as both a binder and a conductive filler. Such materials may be conjugated polymers (i.e., a conjugated n-system polymer), such as, for example, polypyrrole, polythiophene, polyaniline, or a combination thereof. The cathode composition may comprise the binder in an amount of 1 wt % to 15 wt %, or 1 wt % to 9 wt %, or 2 wt % to 5 wt %, or 3 wt % to 4 wt %, based on a total weight of the cathode composition.

The cathode can be prepared by preparing a cathode coating composition comprising the fluorinated carbon and optionally the manganese oxide, and disposing the cathode coating composition on a cathode current collector.

In aspects, the cathode is prepared using a web coating process. The method can comprise preparing the cathode coating composition by combining the cathode active material, a conductive material (e.g., carbon black, graphite), a solid polymer electrolyte, and a binder to form a slurry, and then coating the slurry on a cathode current collector. The web coating process enables the production of a very thin cathode and leads to improvements in rate capability and low temperature performance. A thickness of the cathode may be 500 μm or less, for example, a thickness of the cathode may be 300 μm or less, or 200 μm or less, or 100 μm or less. For example, the thickness of the cathode may be 10 μm to 500 μm, or 20 μm to 400 μm, or 50 μm to 300 μm. In an aspect, the cathode has a thickness of 50 μm to 300 μm. The cathode coating composition can be optimized to achieve a high density with enhanced rate capability.

The cathode current collector comprises aluminum, titanium, stainless steel, carbon, or a combination thereof. The cathode current collector is in the form of a foil, a chemically-etched screen, an expanded metal, a punched screen, a perforated foil, or a combination thereof.

Prior to coating the cathode coating composition, the cathode current collector may be coated with a layer comprising carbon, a noble metal, a carbide, or a combination thereof, to provide stable resistance at the electrochemical interface between the cathode current collector and the fluorinated carbon. In an aspect, the cathode current collector is coated with a thin layer of carbon prior to the application of the cathode composition, to improve stability. The thickness of the carbon layer may be 1 micrometer (μm) to 10 μm, or 1 μm to 5 μm, or 2 μm to 5 μm, or 2 μm to 3 μm.

The cathode coating composition may also be coated onto a non-binding substrate to form a free-standing sheet that is subsequently punched to size and applied to the current collector by pressing. Alternatively, the cathode composition in the form of a slurry or paste is applied to a foil or perforated foil, and then the cathode is dried. Regardless of the preparation method, the cathode composition is compressed or calendared to the minimum thickness that does not detrimentally affecting the power capability of the cell. The amount of cathode composition forming the cathode may be 3 mg/cm² to 150 mg/cm².

The anode comprises an anode composition comprising an anode active material. In aspects, the anode active material comprises lithium metal, a lithium alloy, or a combination thereof. The lithium alloy comprises lithium and at least one metal alloyable with lithium, wherein the metal alloyable with lithium comprises a Group IA element, a Group IIA element, or a combination thereof. In various aspects, the anode active material comprises lithium and at least one of aluminum, tin, silicon, boron, magnesium, sodium, potassium, carbon, an alloy thereof, an intermetallic compound thereof, or a combination thereof.

The anode may be formed by molding an anode composition comprising the anode active material into a desired shape. Alternatively, the anode may be formed by coating a layer of the anode composition on an anode current collector, or alternatively, the anode composition may be cast onto a separate support and a film exfoliated from the separate support is laminated on the metal current collector. The method of preparing the anode is not limited thereto, and any other method suitable for the preparation of an anode may also be used. The form of the anode is not limited, but in aspects may be a thin layer of the anode composition disposed as a on a current collector having an extended tab or lead affixed to the anode layer. Alternatively, the cathode mixture may be in the form of a slurry or paste and applied to a foil or perforated foil, and then dried. The anode current collector comprises aluminum, titanium, stainless steel, carbon steel, or a combination thereof, and may be configured as a foil, a chemically-etched screen, an expanded metal, a punched screen or a perforated foil.

In addition to the anode active material, the anode composition may further comprise a binder, a solvent, a conductive agent, or a combination thereof.

A thickness of the anode may be 500 μm or less, for example, a thickness of the anode may be 300 μm or less, or 200 μm or less, or 100 μm or less. For example, the thickness of the anode may be 10 μm to 500 μm, or 20 μm to 400 μm, or 50 μm to 300 μm.

The non-aqueous battery comprises a solid polymer electrolyte between the anode and the cathode. The solid polymer electrolyte comprises an ionically conducting polymer and an additive comprising inorganic particles, a lithium salt, an ionic liquid, or a combination thereof.

The ionically conducting polymer may be capable of dissolving a lithium salt and coupling lithium ions to facilitate the movement of the lithium ions between the anode and the cathode during electrochemical reactions in the cell. In aspects, the ionically conducting polymer comprises an ion conductive repeating unit comprising an ether monomer, an acryl monomer, a methacryl monomer, a siloxane monomer, or a combination thereof.

The ionically conducting polymer may comprise polyethylene oxide, polypropylene oxide (PPO), polyvinyl chloride (PVC), polyacrylonitrile (PAN), polymethylmethacrylate (PMMA), polyethylmethacrylate (PEMA), polyvinylidene fluoride (PVDF), poly (vinylidene fluoride-co-hexafluoropropylene)(PVDF-HFP), polyphenylene sulfide (PPS), polyetheretherketone (PEEK), polypyrrole, polydimethylsiloxane (PDMS), polyacrylic acid (PAA), polymethylacrylate (PMA), polyethylacrylate, poly-2-ethylhexylacrylate, polybutylmethacrylate, poly-2-ethylhexylmethacrylate, polydecylacrylate, polyethylene vinyl acetate, polytrimethylene carbonate (PTMC), polycaprolactone (PCL), polypropylene carbonate (PPC), polyethylene carbonate (PEC), poly (propylene glycol) (PPG), poly (ethylene glycol), or a combination thereof.

The ionically conducting polymer may be a copolymer including an ion conductive repeating unit and a structural repeating unit. The ion conductive repeating unit may include acrylic acid, methacrylic acid, methyl acrylate, methyl methacrylate, ethylacrylate, ethylmethacrylate, 2-ethylhexylacrylate, butyl methacrylate, 2-ethylhexylmethacrylate, decyl acrylate, ethylene vinyl acetate, ethylene oxide, propylene oxide, or a combination thereof. The structural repeating unit may include styrene, 4-bromostyrene, tert-butyl styrene, divinyl benzene, methyl methacrylate, isobutyl methacrylate, butadiene, ethylene, propylene, dimethylsiloxane, isobutylene, N-isopropyl acrylamide, vinylidene fluoride, acrylonitrile, 4-methylpentene-1, butylene terephthalate, ethylene terephthalate, vinyl pyridine, or a combination thereof.

The ionically conducting polymer may be a block copolymer comprising an ion conductive phase and a structural phase. The block copolymer may include a linear block copolymer, a branched block copolymer, or a combination thereof. The branched block copolymer may be a stereoblock copolymer, a graft polymer, a star-shaped polymer, a comb polymer, a brush polymer, a polymer network, or a combination thereof.

The block copolymer may include a linear diblock copolymer A-B, a linear triblock copolymer A-B-A′, a linear tetrablock copolymer A-B-A′-B′, or a combination thereof. The blocks A and A′ may be the same or different and may be ion conductive polymer blocks. The blocks B and B′ are the same or different and are non-conducting polymer blocks. The ion conductive blocks may independently include a polyethylene oxide (PEO) block, a polysiloxane block, a polypropylene oxide (PPO) block, a polyethylene oxide-grafted polymethylmethacrylate (PEO-grafted PMMA) block, a polypropylene oxide-grafted polymethylmethacrylate (PPO-grafted PMMA) block, a poly (dialkylsiloxane-co-ethylene oxide block), a poly (dialkylsiloxane-co-propylene oxide) block, a polysiloxane-grafted PMMA block, or a combination thereof. The block B may be a non-conducting polymer block, comprising for example, a polystyrene (PS) block, a PMMA block, a polyvinylpyridine block, a polyimide block, a polyethylene block, a polypropylene block, a polyvinylidene fluoride (PVDF) block, a polyacrylonitrile (PAN) block, a polydimethylsiloxane (PDMS) block, or a combination thereof.

In aspects, the solid polymer electrolyte comprises an ionic liquid. An amount of the ionic liquid in the solid polymer electrolyte may be 5 wt % to 90 wt %, or 10 wt % to 90 wt %, or 20 wt % to 90 wt %, or 30 wt % to 90 wt %, or 40 wt % to 90 wt %, or 50 wt % to 90 wt %, or 60 wt % to 90 wt % based on a total weight of the solid polymer electrolyte. In other aspects, an amount of the ionic liquid in the solid polymer electrolyte may be 1 wt % to 50 wt %, or 5 wt % to 40 wt %, or 5 wt % to 30 wt %, or 10 wt % to 30 wt %, or 10 wt % to 20 wt %, based on a total weight of the solid polymer electrolyte.

The ionic liquid may comprise an organic cation and an inorganic anion. The organic cation may comprise an ammonium cation, a pyrrolidinium cation, a pyridinium cation, a pyrimidinium cation, an imidazolium cation, a piperidinium cation, a pyrazolium cation, an oxazolium cation, a pyridazinium cation, a phosphonium cation, a sulfonium cation, a triazolium cation, or a combination thereof. The anion may comprise BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, (FSO₂)N⁻, Cl⁻, Br⁻, I⁻, SO₄²⁻, CF₃SO₃⁻, (C₂F₅O₂)₂N⁻, (C₂F₅SO₂)(CF₃SO₂)N⁻, NO₃⁻, Al₂Cl₇⁻, (CF₃SO₂)₃C⁻, (CF₃)₂PF₃⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻. CF₃CF₂(CF₃)₂CO⁻, (CF₃SO₂)₂CH⁻, (SF₅)₃C⁻, (O(CF₃)₂C₂(CF₃)₂O)₂PO⁻, or a combination thereof.

In aspects, the solid polymer electrolyte comprises a polymer ionic liquid (PIL). In aspects, the polymer ionic liquid comprises a polymerization product of an ionic liquid monomer, or a polymeric compound. The ionic liquid monomer may have a functional group polymerizable with a vinyl group, an allyl group, an acrylate group, and a methacrylate group, and may comprise at least one of the above-listed cations and at least one of the above-listed anions.

The polymeric ionic liquid may comprise a cationic polymeric ionic liquid, an anionic polymeric ionic liquid, a zwitterionic polymeric ionic liquid, or a combination thereof. The cationic polymeric liquid includes a cation in its backbone, and a counter ion of the cationic polymeric liquid is an anion. The anionic polymeric liquid includes an anion in its backbone, and a counter ion of the anionic polymeric liquid is a cation, which is not chemically connected to the backbone. The zwitterionic polymeric ionic liquid includes both a cation and an anion in its backbone, and a counter ion of the zwitterionic polymeric ionic liquid, which is a cation and/or an anion.

The polymer ionic liquid may include a repeating unit that includes a cation comprising an ammonium cation, a pyrrolidinium cation, a pyridinium cation, a pyrimidinium cation, an imidazolium cation, a piperidinium cation, a pyrazolium cation, an oxazolium cation, a pyridazinium cation, a phosphonium cation, a sulfonium cation, a triazolium cation, or a combination thereof, and an anion comprising BF₄⁻, PF₆⁻, AsF₆⁻, SbF₆⁻, AlCl₄⁻, HSO₄⁻, ClO₄⁻, CH₃SO₃⁻, CF₃CO₂⁻. (CF₃SO₂)₂N⁻, (FSO₂)₂N⁻, Cl⁻, Br⁻, I⁻, SO₄²⁻, CF₃SO₃⁻, (C₂F₅SO₂)₂N⁻, (C₂F₅SO₂)(CF₃SO₂)N⁻, NO₃⁻, Al₂Cl₇⁻, (CF₃SO₂)₃C⁻, (CF₃)₂PF₃⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, (O(CF₃)₂C₂(CF₃)₂O)₂PO⁻, or a combination thereof.

In aspects, the PIL may further comprise a low molecular weight polymer, a lithium salt, or a combination thereof. The low-molecular weight polymer may have an ethylene oxide chain. The low-molecular weight polymer may be a glyme, such as, for example, polyethylene glycol dimethylether (polyglyme), tetraethylene glycol dimethyl ether (tetraglyme), triethylene glycol dimethylether (triglyme), or a combination thereof.

In aspects, the solid polymer electrolyte comprises an inorganic particle. The inorganic particle may comprise a metal oxide, a metal hydroxide, a metal carbonate, a metal carboxylate, a metal silicate, a metal aluminosilicate, a metal carbide, a metal nitride, a metal halide, a metal nitrate, a carbon oxide, a carbonaceous material, and an organic-inorganic composite. In aspects, the inorganic particle may comprise Al₂O₃, SiO₂, BaTiO₃, a zeolite, a metal organic framework (MOF), graphite oxide, graphene oxide, a polyhedral oligomeric silsesquioxane (POSS), Li₂CO₃, Li₃PO₄, Li₃N, Li₃S₄, Li₂O, montmorillonite, a garnet-type compound (e.g., Li₇La₃Zr₂O₁₂ (lithium lanthanum zirconate, LLZO), Li₃₊ₓLa₃Zr₂₋ₐMₐO₁₂ (where M is Ga, W, Nb, Ta, or Al, and x is an integer of 1 to 10; doped LLZO), a perovskite-type ceramic (e.g., La_{2/3-x}Li₃ₓTiO₃, lithium lanthanum titanate (LLTO)), a NASICON-type compound (e.g., Li₁₊ₓAlₓTi₂₋ₓ(PO₄) (lithium aluminum titanium phosphate (LATP)), a sulfide-type ceramic (e.g., Li₄₋ₓGe₁₋ₓPₓS₄, lithium germanium phosphorus sulfide (LGPS)), or a combination thereof.

The particle size of the inorganic particle may be less than 100 nanometers (nm). For example, a particle size of the inorganic particles may be 1 nm to 100 nm, or 5 nm to 100 nm, or 5 nm to 70 nm, or 5 nm to 50 nm, or 5 nm to 30 nm, or 10 nm to 30 nm. In aspects, an amount of the inorganic particle in the solid polymer electrolyte may be 5 wt % to 90 wt %, or 10 wt % to 90 wt %, or 20 wt % to 90 wt %, or 30 wt % to 90 wt %, or 40 wt % to 90 wt %, or 50 wt % to 90 wt %, or 60 wt % to 90 wt %. In other aspects, an amount of the inorganic particles in the solid polymer electrolyte may be 1 wt % to 50 wt %, or 5 wt % to 40 wt %, or 5 wt % to 30 wt %, or 10 wt % to 30 wt %, or 10 wt % to 20 wt %, based on the total weight of the solid polymer electrolyte.

In aspects, the solid polymer electrolyte comprises a lithium salt. The lithium salt in the solid polymer electrolyte may have a concentration of, for example, 0.01 molar (M) to 5.0 M, 0.05 M to 4.0 M, 0.1 M to 3.0 M, 0.5 M to 2.5 M, 0.5 M to 2.0 M, or 0.5 M to 1.5 M, based on the weight of the solid polymer electrolyte. The lithium salt may comprise LiSCN, LIN(CN)₂, LiClO₄, LiBF₄, LiAsF₆, LiPF₆, LiCF₃SO₃, Li(CF₃SO₂)₂N, Li(CF₃SO₂)₃C, LiSbF₆, Li(FSO₂)₂N, LiC₄F₉SO₃, LIN(SO₂CF₂CF₃)₂, LiPF₃(C₂F₅)₃, LiPF₃(CF₃)₃, LiCl, LIF, LiBr, LiI, LiAlO₂, LiAlCl₄, LiN(CₓF₂ₓ₊₁SO₂)(C_{y}F_{2y+1}SO₂) (wherein x and y are natural numbers), LiGaCl₄, LiC(SO₂CF₃)₃, LiB(C₆H₄O₂)2, LiN(SO₂CF₃)2, LiN(SO₂C₂F₅)₂, LiB(C₂O₄)₂, Li(CF₃SO₃), lithium difluoro(oxalato)borate, lithium bis(oxalato) borate, or a combination thereof, but is not limited thereto.

In aspects, the solid polymer electrolyte comprises an organic solvent. Examples of the organic solvent comprise dimethyl carbonate (DMC), diethyl carbonate, 1,2-dimethoxyethane (DME), tetrahydrofuran (THF), methyl acetate (MA), diglyme, triglyme, tetraglyme, propylene carbonate (PC), ethylene carbonate (EC), acetonitrile, dimethyl sulfoxide, dimethyl formamide, dimethyl acetamide, gamma-butyrolactone (GBL), and N-methyl-pyrrolidinone (NMP), or a combination thereof. Advantageously, the solid polymer electrolyte is free of glymes such as tetraethylene glycol dimethyl ether (TEGDME), triethylene glycol dimethyl ether (Triglyme), poly (ethylene glycol dimethyl ether) (PEGDME) (Mwₙ: 200-2000), poly(ethylene glycol) (Mwₙ: 200-2000), polyglycol methyl ether (Mwₙ: 200-2000), ethylene glycol dibutyl ether, or a combination thereof.

In aspects, the solid polymer electrolyte is disposed on the anode. The solid polymer electrolyte may be coated directly on a surface of the anode. For example, the surface of the anode may be coated with a solid polymer electrolyte composition and then dried at room temperature to form the electrolyte layer. Alternatively, the solid polymer electrolyte composition may be coated on a separate support to form a thin film or sheet and then disposed on the surface of the anode. A thickness of the solid electrolyte layer may be 40 μm or less. For example, the solid electrolyte layer may have a thickness of 0.01 μm to 40 μm, or 1 μm to 40 μm, or 1 μm to 30 μm, or 1 μm to 20 μm, or 1 μm to 15 μm.

In aspects, the battery includes an electrolyte having a multi-layer structure comprising two or more layers, wherein at least one of the layers is the solid polymer electrolyte. The two or more layers may each independently comprise a liquid electrolyte, a gel electrolyte, and a solid polymer electrolyte. In aspects, the two or more layers may have the same or different compositions. For example, the electrolyte may comprise a multi-layer structure including a first layer, a second layer, and a third layer, where at least one of the first, second, and third layers is a solid polymer electrolyte. The liquid electrolyte and the gel electrolyte may be any material suitable for use as an electrolyte in a nonaqueous lithium battery as long as the material does not react with, or deteriorate, the cathode active material. In aspects, the liquid electrolyte may be the same as the liquid electrolyte described below, which is impregnated in the separator and/or cathode.

The non-aqueous battery may further comprise a separator between the cathode and the anode. In aspects, the separator may be disposed between the cathode and the solid polymer electrolyte. The separator comprises a separator material that is electrically insulating, chemically non-reactive with the anode and cathode active materials, chemically non-reactive with the electrolyte, and insoluble in the electrolyte. In addition, the separator material is selected such that it has a degree of porosity sufficient to allow the electrolyte to flow through during the electrochemical reaction of the cell.

The separator is not limited and may be any separator suitable for use in a non-aqueous lithium battery. The separator may be a porous or nonporous polymer membrane, and may be a non-woven or woven fabric. The separator may comprise, for example, polypropylene, polyethylene, polyamide (e.g., nylon), polysulfone, polyvinyl chloride (PVC), polyvinylidine fluoride (PVDF), polyvinylidine fluoride-co-hydrofluoropropylene (PVDF-HFP), a tetrafluoroethylene-ethylene copolymer (PETFE), a chlorotrifluoroethylene-ethylene copolymer, or a combination thereof. In aspects, the separator may comprise two or more layers of alternating materials, for example, a trilayer separator of polypropylene/polyethylene/polypropylene.

The separator may be impregnated with a nonaqueous liquid electrolyte. The nonaqueous liquid electrolyte may comprise a lithium salt dissolved in an organic solvent. The lithium salt may comprise LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are natural numbers), LiCl, LiI, LiGaCl₄, LiC(SO₂CF₃)₃, LiB(C₆H₄O₂)₂, LiN(SO₂CF₃)2, LiN(SO₂C₂F₅)₂, LiB(C₂O₄)₂, Li(CF₃SO₃), or a combination thereof. The organic solvent may comprise dimethyl carbonate (DMC), diethyl carbonate, 1,2-dimethoxyethane (DME), tetrahydrofuran (THF), methyl acetate (MA), diglyme, triglyme, tetraglyme, propylene carbonate (PC), ethylene carbonate (EC), acetonitrile, dimethyl sulfoxide, dimethyl formamide, dimethyl acetamide, gamma-butyrolactone (GBL), and N-methyl-pyrrolidinone (NMP), or a combination thereof.

In the nonaqueous battery, the cathode may also be impregnated with the nonaqueous liquid electrolyte.

A method of manufacturing the nonaqueous battery is also provided herein. In aspects, the method comprises providing an anode composition comprising an anode active material, wherein the anode active material comprises lithium, a lithium alloy, or a combination thereof; providing a cathode comprising a cathode active material, wherein the cathode active material comprises a fluorinated carbon and a manganese oxide; and disposing a solid polymer electrolyte between the anode and the cathode, wherein the solid polymer electrolyte comprises an ionically conducting polymer and an additive comprising inorganic particles, a lithium salt, an ionic liquid, a polymer ionic liquid, or a combination thereof.

In aspects, the providing of the cathode comprises preparing a cathode composition and disposing the cathode composition on a cathode current collector. Methods of preparing the cathode composition are described above.

In aspects, the providing of the anode comprises prepare an anode composition comprising lithium, a lithium alloy, or a combination thereof, and disposing the anode composition on an anode current collector. Methods of preparing the anode composition are described above.

The form or configuration of the nonaqueous battery is not limited. The nonaqueous battery may be formed in various configurations including, for example, a jelly-roll, Z-fold anode with parallel-plate cathode, or parallel multi-plate (for both anode and cathode) configuration. The cathode may be overlaid with the anode with one or two layers of solid polymer electrolyte, and optionally a separator, interspersed between them. The anode capacity is typically within a range of from about equal to that of the cathode capacity, to about 15%, about 25%, or even about 35% greater than the cathode capacity. In an aspect, the form or configuration of the nonaqueous battery may be a case-negative design, wherein the cathode/anode/electrolyte/separator components are enclosed in a conductive metal casing such that the casing is connected to the anode current collector in a case-negative configuration, although case-neutral design is also suitable. The casing material comprises titanium, stainless steel, nickel, or aluminum. The casing header comprises a metallic lid having a sufficient number of openings to accommodate the glass-to-metal seal/terminal pin feed through for the cathode electrode. The anode electrode may be connected to the case. An additional opening may be provided for adding a liquid electrolyte. The casing header comprises elements having compatibility with the other components of the electrochemical cell and is resistant to corrosion.

The nonaqueous battery according to various aspects may be of any configuration, such as a cylindrical wound cell, a prismatic cell, a rigid laminar cell or a flexible pouch, envelope or bag cell.

A specific example of a non-aqueous battery comprises a cathode comprising a cathode active material layer on a cathode current collector, wherein the cathode active material layer comprises 70 weight percent to 95 weight percent of the cathode active material, and 5 weight percent to 30 weight percent of the first solid polymer electrolyte, each based on a total weight of the cathode active material layer, and wherein an amount of the fluorinated carbon is 90 weight percent to 100 weight percent, based on a total weight of the cathode active material, and the fluorinated carbon comprises the first fluorinated carbon, the second fluorinated carbon, and the third fluorinated carbon. The non-aqueous battery also comprises an anode comprising an anode active material, wherein the anode active material comprises lithium, a lithium alloy, or a combination thereof, and a second solid polymer electrolyte between the anode and the cathode. The first and second solid polymer electrolytes independently comprise an ionically conducting polymer and an additive comprising inorganic particles, a lithium salt, an ionic liquid, or a combination thereof, and a weight ratio of the ionically conducting polymer to the additive is 5:1 to 1:2, 5:1 to 1:1, or 4:1 to 1:1. The ionic liquid, if present, can be contained in an amount of 1 wt % to 50 wt %, or 5 wt % to 40 wt %, or 5 wt % to 30 wt %, or 10 wt % to 30 wt %, or 10 wt % to 20 wt %, based on a total weight of the solid polymer electrolyte.

As another specific example, a cathode comprises a cathode active material layer on a cathode current collector, wherein the cathode active material layer comprises 70 weight percent to 95 weight percent of the cathode active material, and 5 weight percent to 30 weight percent of the first solid polymer electrolyte, each based on a total weight of the anode active material layer, and wherein the cathode active material comprises 70 weight percent to 85 weight percent of the fluorinated carbon and 15 weight percent to 30 weight percent of a manganese oxide, each based on a total weight of the cathode active material, and the fluorinated carbon comprises the first fluorinated carbon, the second fluorinated carbon, and the third fluorinated carbon. The non-aqueous battery also comprises an anode comprising an anode active material, wherein the anode active material comprises lithium, a lithium alloy, or a combination thereof, and a second solid polymer electrolyte between the anode and the cathode. The first and second solid polymer electrolytes independently comprise an ionically conducting polymer and an additive comprising inorganic particles, a lithium salt, an ionic liquid, or a combination thereof, and a weight ratio of the ionically conducting polymer to the additive is 5:1 to 1:2, 5:1 to 1:1, or 4:1 to 1:1. The ionic liquid, if present, can be contained in an amount of 1 wt % to 50 wt %, or 5 wt % to 40 wt %, or 5 wt % to 30 wt %, or 10 wt % to 30 wt %, or 10 wt % to 20 wt %, based on a total weight of the solid polymer electrolyte.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

It will be understood that when an element is referred to as being “on” another element, it can be directly on the other element or intervening elements may be present therebetween. In contrast, when an element is referred to as being “directly on” another clement, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second clement, component, region, layer or section without departing from the teachings herein.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A non-aqueous battery comprising:
an anode comprising an anode active material, wherein the anode active material comprises lithium, a lithium alloy, or a combination thereof;
a cathode comprising a cathode active material layer, wherein the cathode active material layer comprises a cathode active material and a first solid polymer electrolyte, and the cathode active material comprises a fluorinated carbon; and
a second solid polymer electrolyte between the anode and the cathode,
wherein the first and second solid polymer electrolytes independently comprise an ionically conducting polymer and an additive comprising inorganic particles, a lithium salt, an ionic liquid, or a combination thereof,
wherein the fluorinated carbon comprises a first fluorinated carbon having a structure of Formula 1, a second fluorinated carbon having a structure of Formula 2, a third fluorinated carbon having a structure of Formula 3, or a combination thereof:
CFx₁, Formula 1
CFx₂, or Formula 2
CFx₃, Formula 3
wherein, 0.9<x₁≤1.2, 0.4≤x₂<0.9, and 0.8≤x₃≤1.2, and
wherein the first, second, and third fluorinated carbons have distinct discharge capacities when discharged to 2.5 volts.

2. The non-aqueous battery of claim 1, wherein the fluorinated carbon comprises a mixture of at least two of the first fluorinated carbon having a structure of Formula 1, the second fluorinated carbon having a structure of Formula 2, and the third fluorinated carbon having a structure of Formula 3.

3. The non-aqueous battery of claim 2, wherein the fluorinated carbon comprises the first fluorinated carbon, the second fluorinated carbon, and the third fluorinated carbon, wherein x₁ and x₃ are the same and are different from x₂.

4. The non-aqueous battery of claim 2, wherein a weight ratio of the first fluorinated carbon material to the second fluorinated carbon material is from 5:1 to 1:5.

5. The non-aqueous battery of claim 1, wherein an amount of the fluorinated carbon is 5 weight percent to 95 weight percent, based on a total weight of the cathode active material.

6. The non-aqueous battery of claim 1, wherein the cathode active material further comprises a manganese oxide.

7. The non-aqueous battery of claim 6, wherein an amount of the manganese oxide is 5 weight percent to 40 weight percent, based on a total weight of the cathode active material.

8. The non-aqueous battery of claim 6, wherein the manganese oxide comprises MnO₂.

9. The non-aqueous battery of claim 6, wherein the manganese oxide comprises β-MnO₂, Mn⁴⁺O₂, γ-MnO₂, ε-MnO₂, λ-MnO₂, electrolytic manganese dioxide, chemical manganese dioxide, or combination thereof.

10. The non-aqueous battery of claim 1,
wherein the ionically conducting polymer comprises a copolymer comprising an ion conductive repeating unit and a structural repeating unit,
wherein the ion conductive repeating unit comprises acrylic acid, methacrylic acid, methyl acrylate, methyl methacrylate, ethylacrylate, ethylmethacrylate, 2-ethylhexylacrylate, butyl methacrylate, 2-ethylhexylmethacrylate, decyl acrylate, ethylene vinyl acetate, ethylene oxide, propylene oxide, or a combination thereof; and
the structural repeating unit comprises styrene, 4-bromostyrene, tert-butyl styrene, divinyl benzene, methyl methacrylate, isobutyl methacrylate, butadiene, ethylene, propylene, dimethylsiloxane, isobutylene, N-isopropyl acrylamide, vinylidene fluoride, acrylonitrile, 4-methylpentene-1, butylene terephthalate, ethylene terephthalate, vinyl pyridine, or a combination thereof.

11. The non-aqueous battery of claim 1, wherein the first solid polymer electrolyte, the second solid polymer electrolyte, or a combination thereof further comprises an organic solvent comprising dimethyl carbonate, diethyl carbonate, 1,2-dimethoxyethane, tetrahydrofuran, methyl acetate, diglyme, triglyme, tetraglyme, propylene carbonate, ethylene carbonate, acetonitrile, dimethyl sulfoxide, dimethyl formamide, dimethyl acetamide, gamma-butyrolactone, N-methyl-pyrrolidinone (NMP), or a combination thereof.

12. The non-aqueous battery of claim 11, wherein the first solid polymer electrolyte, the second solid polymer electrolyte, or a combination thereof further comprises a lithium salt.

13. The non-aqueous battery of claim 1, wherein the first solid polymer electrolyte, the second solid polymer electrolyte, or a combination thereof further comprises the ionic liquid.

14. The non-aqueous battery of claim 13, wherein the ionic liquid is a polymer ionic liquid.

15. The non-aqueous battery of claim 1, wherein the anode further comprises an anode current collector and an intermediate layer between the anode current collector and the anode active material layer, the intermediate layer comprising carbon, a noble metal, a carbide, or a combination thereof and having a thickness of 1 to 10 microns.

16. The non-aqueous battery of claim 1,
wherein the cathode active material layer comprises 70 weight percent to 95 weight percent of the cathode active material, and 5 weight percent to 30 weight percent of the first solid polymer electrolyte, each based on a total weight of the cathode active material layer, and
wherein an amount of the fluorinated carbon is 90 weight percent to 100 weight percent, based on a total weight of the cathode active material, and
the fluorinated carbon comprises the first fluorinated carbon, the second fluorinated carbon, and the third fluorinated carbon.

17. The non-aqueous battery of claim 1,
wherein the cathode comprises 70 weight percent to 95 weight percent of the cathode active material, and 5 weight percent to 30 weight percent of the first solid polymer electrolyte, each based on a total weight of the cathode active material layer, and
wherein the cathode active material comprises 70 weight percent to 85 weight percent of the fluorinated carbon and 15 weight percent to 30 weight percent of a manganese oxide, each based on a total weight of the cathode active material, and
the fluorinated carbon comprises the first fluorinated carbon, the second fluorinated carbon, and the third fluorinated carbon.

18. The non-aqueous battery of claim 1, wherein the anode comprises lithium and a metal comprising magnesium, sodium, potassium, or a combination thereof.

19. The non-aqueous battery of claim 1, wherein the cathode further comprises a solid polymer electrolyte.

20. A method of manufacturing a nonaqueous battery, the method comprising:
providing an anode comprising an anode active material, wherein the anode active material comprises lithium, a lithium alloy, or a combination thereof;
providing a cathode comprising a cathode active material and a first solid polymer electrolyte, wherein the cathode active material comprises a fluorinated carbon and optionally a manganese oxide; and
disposing a second solid polymer electrolyte between the anode and the cathode,
wherein the first and second solid polymer electrolyte independently comprises an ionically conducting polymer and an additive comprising inorganic particles, a lithium salt, an ionic liquid, a polymer ionic liquid, or a combination thereof,
wherein the fluorinated carbon comprises a first fluorinated carbon having a structure of Formula 1, a second fluorinated carbon having a structure of Formula 2, a third fluorinated carbon having a structure of Formula 3, or a combination thereof:
CFx₁, Formula 1
CFx₂, or Formula 2
CFx₃, Formula 3
wherein, 0.9<x₁≤1.2, 0.4≤x₂<0.9, and 0.8≤x₃≤1.2, and
wherein the first, second, and third fluorinated carbons have distinct discharge capacities when discharged to 2.5 volts.

21. The method of claim 20, further comprising coating the cathode current collector with a layer comprising carbon, a noble metal, a carbide, or a combination thereof prior to the disposing of the cathode composition, and wherein the layer has a thickness of 1 micrometer to 10 micrometers.
